(19) United States
(12) Patent Application Publication
(10) Pub. No.: US 2019/0066121 A1
(43) Pub. Date: Feb. 28, 2019

(54) METHODS AND SYSTEMS FOR ENHANCING THE TRUSTWORTHINESS OF INTERNET SERVICES

(71) Applicant: Rutgers, The State University of New Jersey, New Brunswick, NJ (US)

(72) Inventor: Naftaly H. Minsky, Piscataway, NJ (US)

(21) Appl. No.: 16/112,928

(22) Filed: Aug. 27, 2018

Related U.S. Application Data
(60) Provisional application No. 62/551,955, filed on Aug. 30, 2017.

(51) Int. Cl. G06Q 30/00; H04L 29/06

(52) U.S. Cl. CPC G06Q 30/018; H04L 63/20

(57) ABSTRACT

Methods and systems for enabling an arbitrary Internet service to make a pledge regarding its interaction with clients, such that the pledge can be justifiably trusted by any potential client, even without having any trust in the service itself. An example system includes a pledge registry and a controller computing device. The pledge registry is accessible by client computing devices and includes information relating to promises and laws corresponding to the promises. The controller computing device is configured to provide the service to client computing devices in accordance with a promise. Such a promise may be referred to as a pledge. While a controller computing device may be associated with one service, the registry can serve a plurality of services. Clients can benefit from confidence that the stated promises would be fulfilled, and services can benefit by being able to attract more clients. Governmental entities can benefit by ensuring that service providers conform to federal regulations though the use of a hierarchical structure of promises. SOA-based systems can benefit by having its services create appropriate pledges.

### RELATED APPLICATION

This application claims the benefit of U.S. Provisional Application No. 62/551,955, filed on Aug. 30, 2017. The entire teachings of the above applications are incorporated herein by reference.

### BACKGROUND

Effective interaction between entities over the Internet generally requires a degree of trust between them. To use an Internet service, in particular, one prefers to have a behavioral trust in the service. For example, to use a given service one needs to be able to be confident that a credit card used for payment would be charged the correct amount, that the number of the credit card would not be provided to anyone else, and perhaps not even maintained in the database used by the service. A service already considered to be a highly-reputable service could generate trust simply by promising a certain behavior via its website. But the vast majority of services over the Internet, who have not established a solid reputation, have no way to generate behavioral trust. Such services find it difficult to attract clients and, thus, difficult to compete against established reputable services. This lack of effective competitiveness of electronic commerce reduces the quality of business-to-client (B2C) e-commerce.

### SUMMARY

The disclosed methods and systems provide a solution for enhancing trust of internet services in a scalable fashion. The disclosed methods and systems can be referred to as a Pledging Mechanism (“PleM”), which can provide a solution for enhancing trustworthiness of internet services in a scalable fashion. PleM enables a service provider to make a promise about its interaction with client computing devices that can be justifiably trusted by any potential client computing device, even without having any trust in the service provider itself. A promise made via PleM can be referred to as a pledge, and a service provider that makes such a pledge can be referred to as a P-service.

One example embodiment is a system for enabling a service provider to provide to a client computing device trusted services over the internet. The example system includes a pledge registry and a controller computing device (which may be referred to herein simply as a “controller”). The pledge registry is accessible by client computing devices and includes information relating to a plurality of promises. At least one promise relates to a service provided by the service provider. The pledge registry also includes a plurality of laws corresponding to the plurality of promises. The laws are used to enforce promises for client computing devices. The controller computing device is configured to provide the service to the client computing device(s) in accordance with the at least one promise. A law corresponding to the at least one promise is implemented as a computer program running on the controller computing device. Thus, the system provides a solution for enhancing trust of internet services in a scalable fashion; that is, the system can be used to enable trust of services over the internet among a large plurality of service providers and client computing devices.

In many embodiments, a controller provider can manage a plurality of controller computing devices. The controller provider can be deemed trustworthy, thereby enabling certificates issued by the controller provider to be broadly trusted. In such an embodiment, the controller computing device can authenticate itself using, for example, a certificate of authenticity signed by the controller provider.

In other embodiments, the service provider can provide the controller computing device using trusted platform module technology. In such an embodiment, the controller computing device can authenticate itself using, for example, a certificate of authenticity signed by a manufacturer of a host of the controller computing device and a one-way hash of operating code of the controller computing device.

The service provider can provide information regarding its services to client computing devices. Such information can include, for example, a natural language statement of the promise, an address of the controller computing device, a public key of the controller provider, a one-way hash of the law associated with the promise, and an identifier of an entry in the pledge registry that represents the promise made by the service provider.

A controller computing device associated with providing a service according to a law can be configured to enable the client computing device to identify the law associated with the controller computing device by examining a one-way hash of the law. Examining the one-way hash of the law can include comparing (i) the one-way hash of the law associated with the controller computing device with (ii) a one-way hash of the law received from the service provider.

More than one pledge can be associated with a service provider where one of the pledges can be subordinate to another, thus being in conformance with the other pledge (forming a pledge-hierarchy). A controller computing device can provide client computing devices with a sequence of one-way hashes of laws corresponding to the pledges in such a hierarchy.

Another example embodiment is a method of providing a trusted service by a service provider. The example method includes creating a promise to offer to client computing devices of a service, and creating a law corresponding to the promise. The law is used to enforce the promise for client computing devices. The method further includes integrating the law with a controller computing device as a computer program running on the controller computing device. The controller computing device is used to provide the service to the client computing devices in accordance with the promise. Information can be provided to the client computing devices regarding use of the controller computing device to obtain the service and regarding authentication of the controller computing device. The information provided to a client computing device can include an address of the controller computing device, a public key associated with the controller computing device, and a one-way hash of the law associated with the service.

Creating the promise can include accessing a pledge registry and selecting an existing promise from the pledge registry, or creating and adding a promise to the pledge registry. Creating the law can include selecting an existing law from the pledge registry that is associated with the selected promise, or creating and adding a law to the pledge registry. The service provider can create a natural-language statement of the promise and add to the pledge registry the natural-language statement of the promise.

Another example embodiment is a method of accessing a trusted service. The example method includes receiving from a service provider (i) a promise relating to a service and (ii) information relating to a controller computing device used to provide the service in accordance with the promise. The controller computing device includes a computer program implementing a law corresponding to the promise. The method further includes accessing a pledge registry to verify information relating to the promise, including the law corresponding to the promise. The controller computing device used to provide the service can be authenticated and used to obtain the service in accordance with the promise.

### BRIEF DESCRIPTION OF THE DRAWINGS

The foregoing will be apparent from the following more particular description of example embodiments, as illustrated in the accompanying drawings in which like reference characters refer to the same parts throughout the different views. The drawings are not necessarily to scale, emphasis instead being placed upon illustrating embodiments.

FIG. 1 is a schematic diagram of a system for enabling a service provider to provide to client computing devices trusted services over the internet, according to an example embodiment.

FIG. 2 is a flow chart illustrating a method of providing a trusted service, according to an example embodiment.

FIG. 3 is a flow chart illustrating a method of accessing a trusted service, according to an example embodiment.

FIG. 4 is a schematic view of a computer network environment in the example embodiments presented herein can be implemented.

FIG. 5 is a block diagram illustrating an example computer node of the network of FIG. 4.

### DETAILED DESCRIPTION

A description of example embodiments follows.

Disclosed herein are methods and systems for enabling an arbitrary service provider (which may be referred to herein simply as a “service”) to make promises to its clients regarding its interaction with client computing devices (which may be referred to herein simply as “clients”)—promises that can be justifiably trusted by any potential client, even if it does not trust the service itself. Such a scalable trustworthy promise is referred to herein as a pledge. The ability to create such pledges enhances the competitiveness of many Internet services that lack significant reputation, which can enhance the overall quality of business-to-client (B2C) commerce.

Section 1—Motivating Example

Consider as an example an obscure startup that establishes a web service called “HonestScalper” for scalping theater tickets and such—and which has no reputation to speak of. Potential clients would likely be reluctant to employ this service, in part due to concerns about the service's honesty. Suppose that to allay some of the concerns of its potential clients, HonestScalper makes the following promise—denoted by P1—by stating it on its website:
P1. The Accountability Promise: A copy of every message exchanged between the service HonestScalper and any of its clients c will be time-stamped, digitally signed by HonestScalper, and sent to c.

The possession of a faithful record of one's interactions with HonestScalper may, indeed, allay many of the concerns one may have about doing business with it. Because such a record can be used by a client of HonestScalper to, for example, file suit against the service if he feels cheated by it. But given the presumed lack of significant reputation of HonestScalper, and the obscurity of the startup that established it, there is almost no basis for most potential clients to trust HonestScalper to fulfill its promise. The methods and systems herein provide such a basis for trusting promises made by practically any web service regarding its interaction with its clients.

Section 2—Scalable Behavioral Trust

Effective interaction between actors—software processes or humans—over the Internet generally requires a degree of trust between them. The concept of trust is notoriously elusive and has been defined in a variety of ways. A working definition of trust is the following: having trust in some property P of a given actor x means having a justified confidence that x satisfies P. Of course, the concept of justified confidence is elusive as well, but perhaps less so than the concept of trust itself, as it is less subjective. For example, many would agree that having confidence that an obscure web service S would fulfill the promises it makes on its website is not justified, but that it may be justified if S has a good and solid reputation regarding such promises.

Three different, but interrelated, trust modalities can be distinguished. They are called: reputation-based trust (or r-trust); identity trust (or i-trust); and behavioral trust or (b-trust). These modes of trust can be characterized as follows.
An r-trust in a given actor x is a trust in some broad qualities of x, such as its honesty, competence, and reliability (see Reference 5). Such a trust in x is broadly justified by its reputation (see Reference 10).
An i-trust in a given actor x is a trust in some aspects of the identity of x (see Reference 6)—such as its public-key, its name, its position and role in some social context, etc. Such a trust is most often justified via digital certificates, signed by a highly reputable certification authority (CA).
A b-trust in a given actor x, is the trust that x complies with a given protocol when interacting with other actors. For instance, the trust that the HonestScalper service, mentioned above, satisfies its promise P1, would be a case of b-trust. In other words, b-trust is defined here as a trust in the interaction behavior of a given actor and not in its internal behavior.

Of particular concern is what can be called the scalability of trust, which is quite different from the conventional concept scalability of an algorithm or of a system. This concept can be defined as follows: A trust modality is considered scalable if practically anybody can make itself trustworthy—where “trustworthy” means that it can be justifiably trusted by many actors, widespread over the Internet.

The status of the scalability of the first two trust modalities above can be described as follows: First, r-trust is inherently unscalable because solid reputation of a given actor x requires a large number of continues reviews of its performance, by a large number of actors that interact with it. There are, of course, many highly reputable Internet sites—such as Amazon, Google, Verisign, and others—but it is self-evident that only a small percentage of the Internet actors can garner such reputation. Second, i-trust can be made scalable, via certificates signed by highly reputable certification authorities (CAs) (see Reference 15), organized into a public key infrastructure (PKI).

The disclosed methods and systems enable behavioral trust to be scalable. The concept of behavioral trust appears relatively rarely in computer science literature, and it is the least utilized among the three trust modalities mentioned above. Yet, this modality of trust is required in many application domains. Provided herein are example of client-server interaction, where a server needs its clients to trust its behavioral promises—such as promise P1 of the HonestScalper service presented above.

There are several published approaches for providing behavioral trust, but none are scalable. First, a website with a solid reputation can generate widespread behavioral trust in the service it provides simply by promising—on its website, say—that it will behave in a certain manner (see Reference 10). But such b-trust is not scalable because, as explained above, reputability is not scalable. Second, two elaborate techniques for providing b-trust in a given actor x have been proposed: (a) by systematic monitoring of the interactive activities of x (see References 3 and 17); and (b) by the verification that the code of x actually satisfies a given interactive protocol (see References 9 and 16). It is fairly clear that these techniques are not scalable and not reliable. Finally, one can provide for b-trust in a given actor x by using a trusted third party (TTP) as its surrogate. But the conventional concept of TTP does not support scalable b-trust, as described below.

Section 3—System/Method Overview

The present disclosure introduces a mechanism that enables an arbitrary Internet service, such as HonestScalper above, to enforce its promise P, so that it can be justifiably trusted by practically any Internet actor. Such a scalably trusted promise can be called a pledge, and a mechanism for making such pledges can be called a pledging mechanism (or PleM). To clarify the difference between the terms “promise” and “pledge” as used here, a promise P is an informal assurance that a service offers to its clients, which can be written in a natural language, and a pledge is a promise P enforced via PleM or similar mechanism, which is sometimes called a pledge P (where P can also be the name of the promise). A service S that makes such a pledge may be referred to herein as a P-service, denoted by S_{P}. The availability of PleM can benefit many commercial websites by enabling them to make scalably trustworthy promises that would attract clients. This can give obscure services, such as the HonestScalper example, a fair chance to compete against well-known services in a similar domain of commerce.

Moreover, PleM can provide broad benefits to business-to-client (B2C) e-commerce in general in several respects: First, the competitiveness of B2C commerce is likely to be enhanced. This would encourage innovation, and thus help improve the overall quality of e-commerce. Second, the scalability of b-trust may reverse the current trend of centralization of B2C commerce, caused by small businesses increasingly operating through a large popular service, such as Amazon.com. Finally, a wide use of such trustworthy promises would provide clients with dependable means for selecting suitable services, based on pledges they make.

Section 3.1—The Gist of PleM

The informal promise P of a service S can be converted into a pledge using a surrogate S′ that serves as an intermediary between S and its clients, and which can be scalably trusted to ensure that the given promise P will be satisfied. It may seem natural to employ the conventional concept of trusted third party (TTP) for such a surrogate. But, unfortunately, the trust provided by TTP is not scalable, as described below.

Conventional TTP can work well in the following situation: Consider an obscure service S that wants to ensure a single client c that its promise P will be fulfilled. To accomplish this, S can interact with c via a TTP S′ that enforces P, and that is trusted by c. There are several conditions that can provide the justification for c to trust the surrogate S′ of S, even if it does not trust S itself. The following are examples: (a) c trusts the creator of S′; (b) c examines the code of S′ and confirms that it enforces the promise in question; or (c) the promise P is very popular, and the TTP S′ that enforces it is used by many services—gaining a high level of reputation (see Reference 4).

But the conventional concept of TTP does not scale. That is, it does not enable practically any service to make its promise so that it would be trusted by a practically any client. Indeed, none of the above three conditions for trusting a TTP are satisfied here, for the following reasons: (a) it is unreasonable to expect a widespread set of clients to trust the creator of a surrogate built to enforced a specific promise of an obscure web-server; (b) most potential clients of a given server S cannot be expected to verify that the code of its surrogate S′ enforces its promise; and (c) although there may be promises that are sufficiently popular for their enforcers to gain solid reputation, many, if not most, services will likely want to make their own, specific, promises. So, the conventional concept of TTP cannot be used for enabling trustworthy pledges to be made by arbitrary services.

The disclosed methods and systems use a scalable variant of the concept of a TTP, formed from two distinct parts, which are trusted for different properties and for different reasons, and which are provided in different ways, by different stakeholders. These two parts are:
1. A Law: A formal and executable statement of promise P, called the law of P (denoted by L_{P}). Such a law can to be written in a suitable programming language, which can be referred to as a law language. The law can also be referred to herein as a set of automated rules. In practice, the law may take the form of programming construct (such as one or more automated rules) representative of a law, or a multi-element data structure representative of a plurality of laws, where different elements of the data structure represent different laws or rules.
2. A Controller: A computing device built to mediate between any given service and its clients, subject to any valid law, which is written in a law-language and built into the controller. The controller, like a compiler, can be generic.

This type of surrogate may be referred to as a dual TTP, or a DTTP. A DTTP can be implemented, for example, using a middleware called law-governed interaction (LGI) (see Reference 12, incorporated herein by reference).

The construction of this surrogate may consists of three steps: (a) acquiring a generic controller C; (b) constructing a law L_{P} that would satisfy promise P when executed by a controller C; and (c) loading law L_{P} into C.

For a DTTP-based surrogate to be trustworthy, i.e. scalably trusted, each of its parts—the controller and the law—should be trusted scalably. The following describes the basis of such trust, after characterizing example types of promises that can be made to be pledges by means of a surrogate.

Section 3.2—The Nature and Range of Feasible Pledges Enabled by PleM

Since a pledge made by a service S is enforced by its surrogate S′, it can be formulated in terms of the interactions of the surrogate S′ with the service S, with its clients, and perhaps with other actors, such as a bank that manages credit cards used by clients for payment, such as under the example P6 pledge, presented below. But the pledge must be independent of the code of S itself, and of its behavior. So, for instance, the example HonestScalper service would not be able to pledge that it charges a price for its tickets that is no more that 10% above of what it paid for them. This is an example limitation on the range of pledges that can be made via PleM, but PleM still enables a wide range of pledges, which can help attracting clients to a service that makes the pledges. The following are samples of the types of pledges that can be made via PleM. They can be used as building blocks that can be combined in several ways into a single pledge that a given service may want to make. A formal law (set of rules) that represents one of these pledges is spelled out below. Two kinds of pledges can be distinguished. Described first is the concept of an independent pledge, which can be defined by a single service at its will. Second is the concept of a subordinate pledge, which is constrained to conform to another pledge: its superior. More generally, a subordinate pledge may be constrained to conform to a hierarchy of several pledges.

Independent Pledges

An independent pledge is a pledge enforced via a single LGI law, which may be written by a service or selected by the service from a list of laws. Listed below is a sample of potentially useful pledges of this kind. Note that each of the pledges described below may have many variants that may be used by many different services.

P1. Accountability: This type of pledge promises to each of a service's clients to send to the client time-stamped and signed copies of all client-server interactions. One variant of this pledge can promise to supply clients with copies of only some selected interactions.

P2. Fair Exchange: The term “fair exchange” can refer to a class of contracts between a server and his client—or, in the present case, pledges of a server to its clients—regarding the exchange of goods and services with payments (see Reference 4). For example, a server that provides some kind of prepaid services may pledge to respond to any service order that requires a deadline—by either providing the requested service in time, or by declining it and returning the payment it received. A common realization of fair exchange between a server and a single client is via a conventional TTP. The use of DTTP would make fair-exchange scalable.

P3. Money-back guarantee: Suppose that a service S responds to paid orders of text files by its clients, by sending them only part of the requested file in plain text, while the rest of it is encrypted. The service can make the following pledge: Each client gets a grace period, of a specified length, within which it can cancel the purchase, and get its money back. If the purchase is not canceled within this grace period, the client is pledged to get the key to decrypt the rest of the text.

P4. Service Level Agreement (SLA): A service can pledge that if it does not respond to a request within a specified time period, it will send the client a partial refund, which can depends, in a specified manner, on the purchase price it received and on the amount of delay in responding to it.

P5. Honoring on-line commitments: A service may make certain commitments during a conversation with a client. For example, consider a service that sells airline tickets and that enables clients to reserve a ticket for a short period of time. Such a service may want to pledge not to sell the reserved ticket to anybody else during this period, and to sell it to this client, for the original price, if it requests the ticket in time.

P6. Secure handling of credit cards: Using credit cards for payments carries the following risks: (a) a service may charge the card more than a specified fee, and (b) the service may use the credit card number for various illicit purposes. But the service may pledge to have the credit card charged the correct amount by the surrogate by communicating with a bank and without transferring the credit card's number to the service itself.

P7: A privacy policy: A declared privacy policy of a service—such as not to reveal to anybody the identity of its clients—can be made scalably trustworthy by never transferring the sensitive information to the server itself. Instead, such information would be kept by the surrogate, which operates on the information as required.

Subordinate Pledges

Consider a set of mail-order pharmacies. Such pharmacies may be required by the government to log their activities on some governmental audit trail. To ensure that they the pharmacies comply, they may be required to make a suitable pledge. The law that enforces this pledge can be called a logging-law, defined informally as follows:

P8. Logging: A copy of each message sent to this service by a client, and of each message sent to a client by this service, would be sent—time-stamped and digitally signed—to a specified logging service.

Note that the logging service mentioned above can be a block chain. A block chain is arguably more secure and reliable than a conventional service maintained by the government. But note that just expecting all pharmacies to follow promise P8 without enforcing it via PleM is not enough. A given pharmacy may avoid logging certain exchanges with clients, and may log incorrect exchanges.

Now, while requiring all mail-order pharmacies to enforce promise P8—that is, making it into a pledge, each pharmacy can be enabled to make its own individual pledge—provided that such an additional pledge does not contradict Pledge P8 required by the government. This type of pledging can be realized via the LGI concept of conformance hierarchy (see Reference 1) of laws. This is a tree of laws in which every law is guaranteed to conform to its recursively superior laws. So, the above pharmacy example would require the law representing the individual promise of a given pharmacy to be subordinate to the logging-law defined by the government, and, thus, be in conformance with the logging-law.

Moreover, there is no need for the government itself to ensure that all mail-order pharmacies conform to the logging law by some kind of dynamic monitoring of the activities of such pharmacies. This is because any client of a pharmacy can readily recognize the structure of the law that enforces its pledge, and it can immediately sense the failure of the pledge of the given pharmacy to conform to the government logging law. So there is no need for dynamic supervision of the activities of pharmacies to effectively ensure that all such pharmacies observe the logging law.

There are other applications of subordinate pledges, which do not involve governmental mandates. For example, a given set of services may agree on standard pledges that all of them should make to their customers. As a particular example, a set of vendors of theater tickets may agree to operate under the accounting pledge (P1) as a standard, while each of them may want to distinguish itself by making its own pledge that does not contradict P1.

Section 4—The Trustworthiness of Pledges

For a pledge made by a surrogate S′ of a service S to be trustworthy, that is, to be justifiably and scalably trusted, each of its two parts (namely, the controller and the law) need to be independently trustworthy. And, as described below, being trustworthy can have different meanings for these two parts of a DTTP-based surrogate, requiring different techniques for trustworthiness to be achieved.

Section 4.1—The Trustworthiness of Controllers

Recall that a controller can be a generic computing device built to mediate between any given service and its clients, subject to any well-formed law. Suppose, now that there is such a well-tested and highly-reputed controller, which may be referred to as the “original controller,” denoting it by C_{O}. For example, the controller developed for LGI can be viewed as such an original controller. Any faithful copy of C_{O} can be called an “authentic controller” and is an authentic controller that is expected to be part of every DTTP-based surrogate under PleM. One may question what is the basis for trusting the controller of a given surrogate to be authentic, and how can such trust be scalable. Two example ways for providing such a basis include: (1) the use of a controller provider (CoP); and (2) self-created controllers based on TPM technology.

Section 4.1.1—Trustworthy Controller Provider (CoP)

A trustworthy CoP is a service that maintains a set of authentic LGI-controllers and leases their use—possibly for a fee—to any actor over the Internet. For such controllers to be trusted as authentic, the CoP should be managed by a highly-reputable organization and can provide each of its controllers with a digital certificate signed by its own certification authority, thus vouching for the controllers' authenticity. Thus, any actor that interacts with a surrogate, including the clients of service S and the service S itself, can authenticate the controller part of S′ using a certificate provided by the CoP.

Section 4.1.2—Self-Created TPM-Based Controllers

A service can create its own authentic controller using TPM technology or some variant of this technology. TPM, or Trusted Platform Module (see Reference 7), provides support for remote attestation of a computing platform. Remote parties can assess that a peer computer equipped with a TPM chip is in the expected state by accessing a one-way hash of the software configurations maintained on this computer. A TPM-based controller can authenticate itself via two complementary ways: (a) via a certificate that asserts that it is running on a TPM-host; and (b) via one-way hashes of the code of the controller, along with the operating system of its host. Note that TPM is hard to use on an application having software that may change frequently because every such change requires the sending of new hashes to all potential users of the system. But this difficulty is only minor in the present case because the code of a generic controller is not expected to change frequently, and the code of the law—which is authenticated separately—would not be included in the code of the controller, because it is generic, so all controllers would have the same hash. (Note, however, that TPM is just one of several analogous architectures, such as the trust zone architecture (see Reference 14), which can be used for implementing controllers.)

Section 4.2—The Trustworthiness of the Law of a Surrogate

For an arbitrary client c to trust the pledge of a given P-service S, it is not enough to trust the authenticity of the controller part of the surrogate S′ of S. Client c also needs to trust the law L_{P} part of S′ in two respects: (a) trusting the law L_{P} to fulfill the informal promise P made by S; and (b) trusting that the informal promise P is useful to it.

Client c can obtain the one-way hash of this law during its handshake with the controller, and it can get the text of the law identified by this hash, which is made available to anyone by the PleM mechanism. But most clients would not be able to understand such a law, and many of them may not be able even to appreciate the value of the informal promise of S. So, many clients may have to rely on some level of reputation of the law and of the promise it is meant to represent.

Reputation is important even for trusting controllers. But since generic controllers are identical, one needs to rely on the reputation of only a few entities, including the single original-controller C_{O}, along with the reputation of the organization that maintains the CoP. But here, there are a large number of different laws, whose reputations need to be evaluated and maintained. PleM accomplishes this via a component that may be referred to as a pledge-registry (PR), described below. It is worth noting that the issue of trusting the law did not arise under the LGI mechanism, which introduced the concept of DTTP-based surrogate. This is because LGI did not feature the concept of a promise that the law is supposed to represent and, thus, did not require the concept of a pledge registry.

Section 4.2.1—Pledge Registry (PR)

The concept of the disclosed pledge registry has dual aspects. The first aspect has two parts: (1) to provide potential clients with information that would help them decide whether to trust that a given law Lₚ satisfies the promise P that it is supposed to enforce, and (2) to help any given client to decide whether the informally stated promise P is useful enough for it to use the P-service. The other aspect of PR is to provide potential services with a registry of pledges, which they may use for creating their own pledges. To satisfy these objectives, PR contains a set of records, one per pledge. (Note, a single pledge may be used by several services, and a pledge record does not specify the services that use it). An example structure of these records is described broadly below.

1. Identifier: A unique identifier of this record.

2. Promise: The promise P—i.e., the informal statement that is claimed to be satisfied by the law in question.

3. Law: The law L_{P} that that constitute the formal statement claimed to satisfy the promise P when executed by a controller.

4. Hash: The one-way hash of L.

5. Evaluations: This component is a set of evaluations of the following two issues: The degree to which promise P is satisfied by law L_{P}, and the value of the pledge P for the potential clients of a P-service. These evaluations may be written by either designated experts, or by random users. It is expected that the only mutable component of these records would be the evaluations. A user that would be allowed to update this component can vary from embodiment to embodiment.

The pledge registry is expected to be used relatively rarely under the PleM mechanism. It is, therefore, unlikely to become a bottleneck, and it can be easily replicated for the sake of fault tolerance and security.

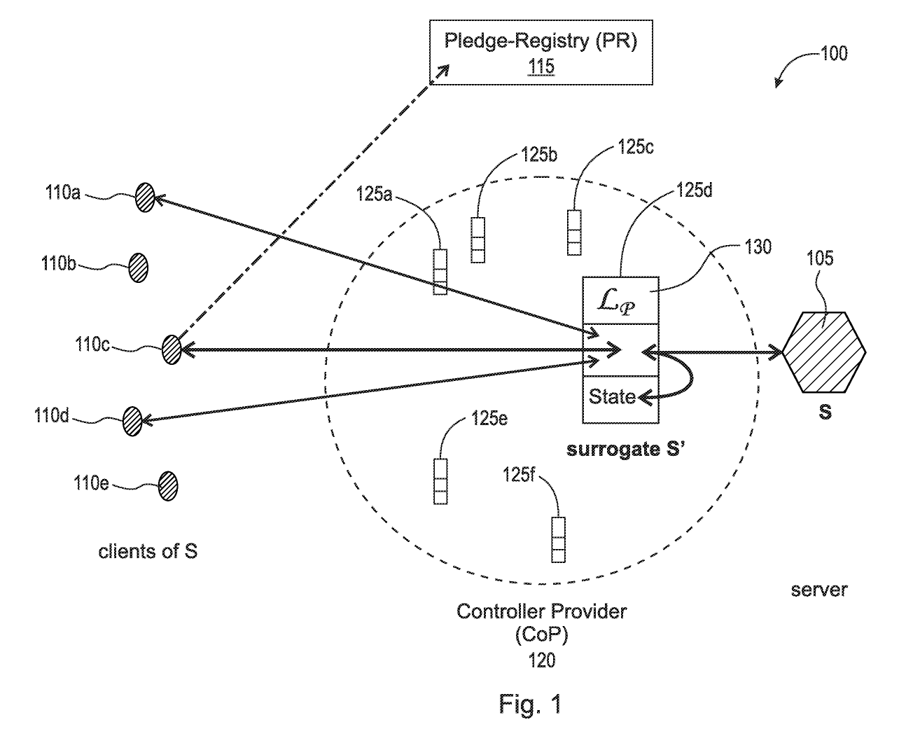

FIG. 1 is a schematic diagram of a system 100 for enabling a service provider 105 to provide to client computing devices 110a-e trusted services over the internet, according to an example embodiment. The example system 100 includes a pledge registry 115 and a controller provider 120. The pledge registry 115 is accessible by client computing devices 110a-e and includes information relating to a plurality of pledges. The pledge registry may be implemented, for example, using a database or other type of data store. At least one pledge relates to a service provided by the service provider 105. The pledge registry 115 also includes a plurality of laws corresponding to the plurality of pledges. The laws are used to enforce pledges for client computing devices. The controller provider 120 manages a plurality of computing entities called controllers 125a-f. Although six controllers are shown in FIG. 1, any number of such controllers can be used. At least one of the controllers 125d is configured to mediate between a service and its clients, such as 110c, in accordance with a pledge. A law 130 corresponding to the at least one pledge is implemented as a computer program running on the controller 125d. The system 100 provides a solution for enhancing trust of internet services in a scalable fashion; that is, the system 100 can be used to enable trust of services over the internet among a large plurality of service providers and client computing devices.

Section 5—Use of the PLeM Mechanism

The following describes an example use of the PLeM mechanism by first describing the creation of a new P-service, and second, by describing how such a service can be used by clients.

Section 5.1—Creation of a P-Service

It is important to point out that while a service S can operate as a P-service via a surrogate S′, it can also offer its services without any pledge by interacting directly with clients. Moreover, S can create several different P-services subject to different pledges via different surrogates. The following describes the formation of one such P-service.

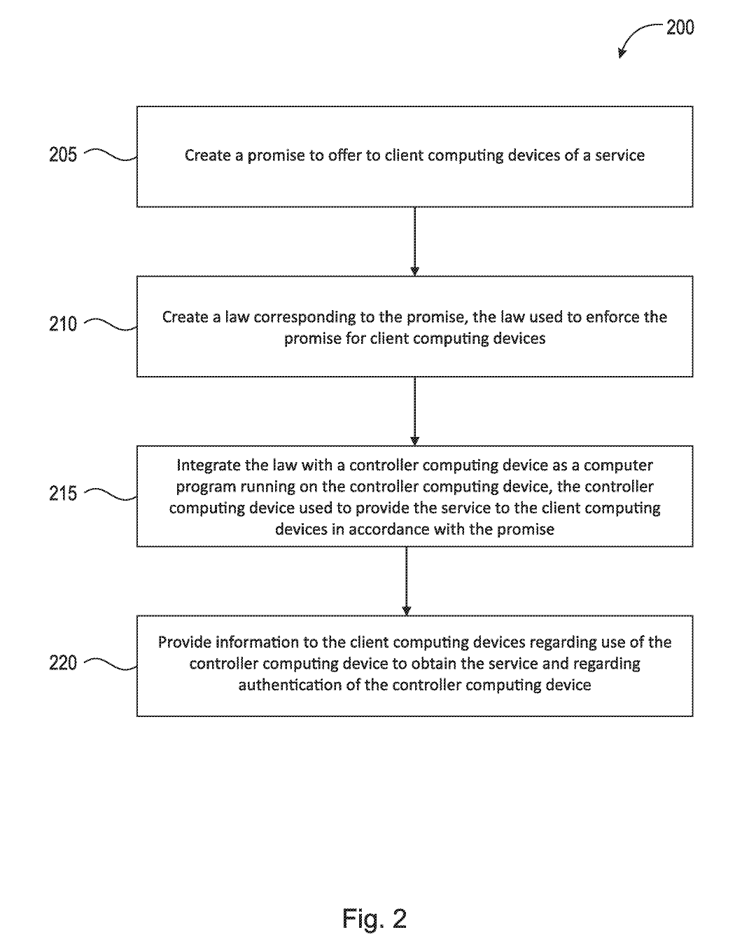

FIG. 2 is a flow chart illustrating a general method 200 of providing a trusted service, according to an example embodiment. The example method 200 includes creating 205 a promise to offer to client computing devices of a service, and creating 210 a law corresponding to the promise. The law is used to enforce the promise for client computing devices, thus making it a pledge. The method 200 further includes obtaining 215 access to a controller computing device and integrating the law with the controller as a computer program running on the controller. The controller is used to provide the service to the client computing devices in accordance with the promise. Information can be provided 220 to the client computing devices regarding use of the controller to obtain the service and regarding authentication of the controller. The information provided to a client computing device can include an address of the controller, a public key associated with the controller, and a one-way hash of the law associated with the service.

In a more detailed example, for a service S to create a P-service S_{P}, the service can carry out the following steps:

1. Specifying, or choosing from the PR, a promise P, along with the law L_{P} which would fulfill the promise if enforced by a controller. This can be done in one of two ways: First, S can create both the promise and its law, in which case it should create an appropriate entry in the registry PR. Second, S can choose from the PR a promise that it would like to make, along with its law.

2. Procuring a controller from the CoP, and loading law L_{P} into it—thus forming its surrogate S′.

3. Forming a “handle” of the newly formed P-service S_{P}, which can be used by clients of S_{P} to access and authenticate it. The handle of S_{P} can have the following components:
The LGI-address of the surrogate S′ of S. (This is the address that a client needs to use to communicate with S_{P}, by means of conventional TCP/IP messages.)
The identifier of the entry of pledge P in the pledge registry PR. (A potential client can use this identifier in order to find out what is being said by others about this pledge.)
The public key of the certification authority of the CoP, to be used by a client to authenticate the surrogate S′.
The one-way hash of law L_{P}, to be used by the client to authenticate the law of the surrogate S′.

The handle of S_{P} can be provided by S itself to any client who asks for it, but it can also be stored in a registry.

Section 5.2—Use of a P-Service by Clients

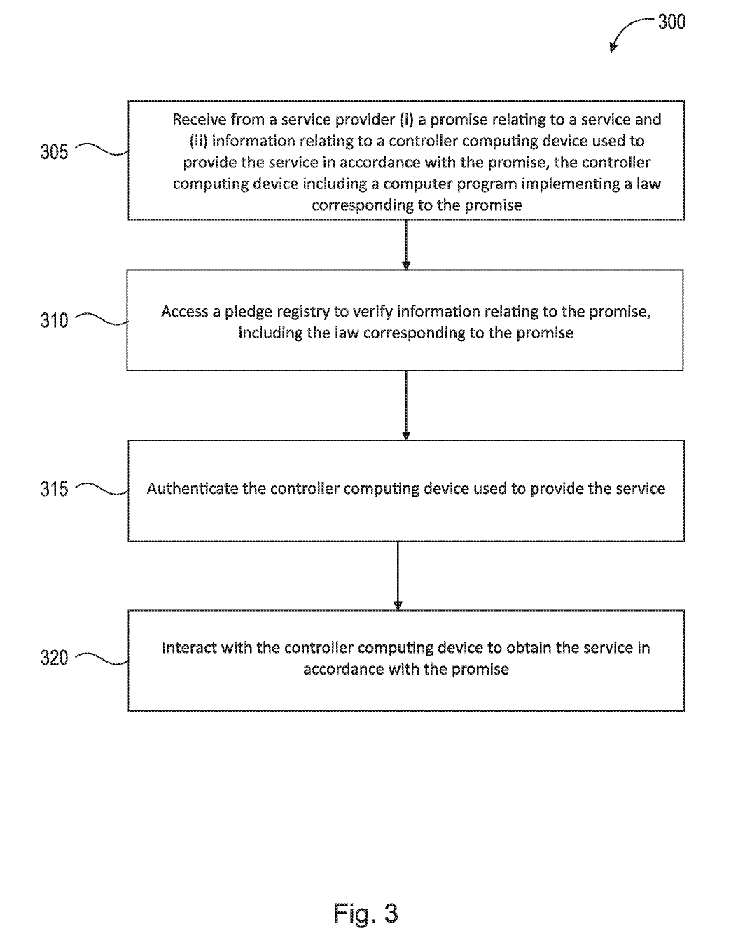

FIG. 3 is a flow chart illustrating a general method 300 of accessing a trusted service, according to an example embodiment. The example method 300 includes receiving 305 from a service provider (i) a pledge relating to a service and (ii) information relating to a controller computing device used to provide the service in accordance with the pledge. The controller includes a computer program implementing a law corresponding to the pledge. The method further includes accessing 310 a pledge registry to verify information relating to the pledge, including the law corresponding to the pledge. The controller is used to provide the service can be authenticated 315 and used to obtain the service 320 in accordance with the pledge.

In a more detailed example, it is assumed here that the potential client c of S learns about its P-service S_{P}, and gets its handle, from S itself. Recall that S may provide services without any pledge in parallel to the pledged service S_{P}, but it may also be used just for directing its clients to S_{P}.

Before using S_{P}, client c may want to confirm that it likes the promise P made by this service, and that the law L_{P} does fulfill the promise. Client c can accomplish this by examining both P and its law, and/or by reading the evaluations posted in the record of this pledge in the pledge registry PR—the identifier of this record is provided by the handle of S_{P}, that client c received from S.

Once client c decides that it wants to use S_{P}, it can communicate with it using the address of the surrogate S′ of S_{P}—which is provide by the handle of the service. (Client c itself does not have to operate under LGI. It can communicate with S_{P} via standard TCP/IP or HTTP messaging). To use the S_{P} service, client c should validate that its surrogate S′ runs on an authentic LGI-controller, subject to the right law. This can be done because an authentic controller provides the following two pieces of information to any interlocutor during the handshake with it: (a) a digital certificate signed by the CA of the CoP, which vouches for the authenticity of S′; and (b) the one-way hash of the law L under which this controller operates. Client c can verify the digital certificate provided by the controller because the public-key of its signer—the CA of the CoP—is included in the handle of S_{P}. Client c can compare the hash of the law under which S operates with the hash provided in the handle.

The use of a P-service is also depicted, schematically, in FIG. 1. This figure depicts three clients communicating with service S via its surrogate S′ of S_{P}, which is assumed to operate subject to the accountability-pledge P1. The details of the interaction of one of the client are shown in heavy arrows. The surrogate S′ of S_{P} is depicted as communicating with S itself, as required by the accountability pledge. The backward arrow into the state of the surrogate represents making changes to this state.

Section 5.3—Justification of a Client to Trust the Pledge of a Given Service

A justification for trusting that a P-service S_{P} fulfills the promise P of the service S rests on three parts. First, one needs a justified confidence that the two infrastructure components of the pledging mechanism—namely the CoP, and the pledge registry PR—operate correctly, as specified. Moreover, in the case of a pledge that involves external services, such as the bank that issued the credit card used by the client for making a payment—such as under example pledge P6 in section 3.2—one needs to trust such services as well. The justification of all such trusts needs to be based on the reputation of these services.

Second, one needs to verify that the surrogate S′ of S_{P} runs on an authentic controller, subject to law L_{P}. This is done, as explained above, as follows: (a) authenticating the controller by the digital certificate signed by the CA of the CoP; and (b) authenticating the one-way hash of the law L under which the controller operates.

Third, one needs to establish that the law L_{P}, specified in the handle of S_{P}, fulfills the pledge P of S. This can be done by one or both of the following steps: (1) Analyzing the actual law L_{P}, which is stored in the handle of the service S_{P}. This requires that the client is capable of understanding the law-language in which the law is written. And (2) by examining the evaluations of the law by experts and by other clients of this law, as reported in the PR.

Section 6—Example of a Law

The following is an example law for enforcing the accountability promise P1. The law is written in a language based on CoffeeScript, a version of the JavaScript programming language, which can serves as a law-language of LGI. The example law has four rules, each rule explained with a comment denoted by “#”:

law (accountability, language (coffeescript))

# R0: If an agent claims itself as a server, then mark it as a server in the control state.

```
UPON “adopted”, ->
    if @arguments.server is true
    DO “set”, key: “server”
  return true
```

# R1: All sent messages should be forwarded. A server agent must also send a copy of the interaction and its signature to the receiver.

```
UPON “sent”, ->
    DO “forward”
    if CS(“server”) is true
            log = [“sent”, @message, @timestamp]
            DO “forward”, sender: @self, receiver: @receiver, message:
                    type: “signature”
                    log: log
                    signature: [SIGN(log), @public_key]
    return true
```

# R2: All received messages should be delivered. A server agent must also send a copy of the interaction and its signature to the sender. To avoid messaging loop, if the received message is a signature, then it won't cause another responding signature message.

```
UPON “received”, ->
    DO “deliver”
    if CS(“server”) is true and @message.type is not “signature”
            log = [“received”, @message, @timestamp]
            DO “forward”, sender: @self receiver: @sender, message:
                    type: “signature”
                    log: log
                    signature: [SIGN(log), @public_key]
    return true
# R3: Gracefully disconnect.
UPON “disconnected”, ->
    DO “quit”
    return true
```

Section 7—Example Benefits of Using of the Disclosed Methods and Systems

(1) Clients of a P-service can benefit from the virtual certainty that the pledge P of the service would be honored.

(2) Services can benefit by being able to attract more clients due to the pledges they operate under. Services can do this without having to operate as part of a reputable service like Amazon.com. This is an important advantage, for several reasons. First, they can devise their own format and advertising mechanisms. Second, they can avoid the dangers of the host service, such as Amazon.com, from essentially stealing ideas from the service, and its body of customers, and selling them as its own. Many services may be willing to pay some price for such independence.

(3) The government can benefit by ensuring that various types of vendors conform to government policies, as demonstrated by the example pledge P8 in Section 3.2.

(4) PLeM can have an important impact on (SOA)-based systems. Service-oriented architecture (SOA) is an approach to the architecture of large and open distributed systems composed of autonomous and heterogeneous services, which may be dispersed over the Internet, written in different languages, and designed, constructed, and even maintained under different administrative domains. The use of pledges by the various servers of an SOA-based system would enhance the dependability and security of such a system.

(5) A licensee that maintains the infrastructure of PleM can benefit by fees paid to it by the various services that operate under PleM.

Section 8—Computer Network Operating Environment

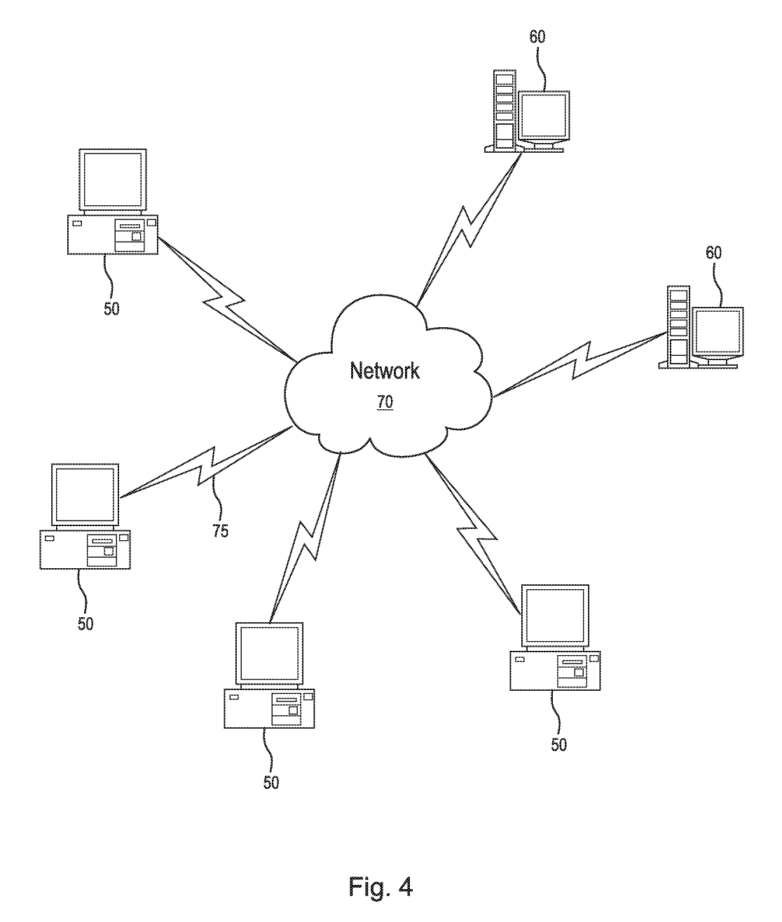

FIG. 4 illustrates a computer network or similar digital processing environment in which the present embodiments may be implemented. Client computer(s)/devices 50 and server computer(s) 60 provide processing, storage, and input/output devices executing application programs and the like. Client computer(s)/devices 50 can also be linked through communications network 70 to other computing devices, including other client devices/processes 50 and server computer(s) 60. Communications network 70 can be part of a remote access network, a global network (e.g., the Internet), cloud computing servers or service, a worldwide collection of computers, Local area or Wide area networks, and gateways that currently use respective protocols (TCP/IP, Bluetooth, etc.) to communicate with one another. Other electronic device/computer network architectures are suitable.

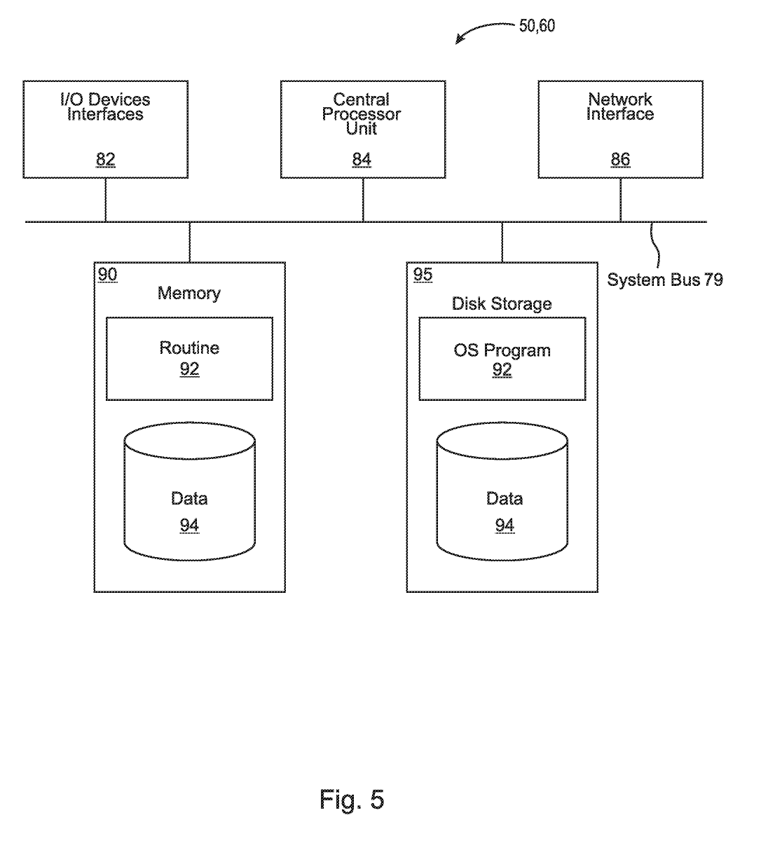

FIG. 5 is a diagram of the internal structure of a computer (e.g., client processor/device 50 or server computers 60) in the computer system of FIG. 4. Each computer 50, 60 contains system bus 79, where a bus is a set of hardware lines used for data transfer among the components of a computer or processing system. Bus 79 is essentially a shared conduit that connects different elements of a computer system (e.g., processor, disk storage, memory, input/output ports, and network ports) that enables the transfer of information between the elements. Attached to system bus 79 is I/O device interface 82 for connecting various input and output devices (e.g., keyboard, mouse, displays, printers, and speakers) to the computer 50, 60. Network interface 86 allows the computer to connect to various other devices attached to a network (e.g., network 70 of FIG. 4). Memory 90 provides volatile storage for computer software instructions 92 and data 94 used to implement many embodiments (e.g., code detailed above and in FIGS. 2 and 3 including routines 200 and 300). Disk storage 95 provides non-volatile storage for computer software instructions 92 and data 94 used to implement many embodiments. Central processor unit 84 is also attached to system bus 79 and provides for the execution of computer instructions.

In one embodiment, the processor routines 92 and data 94 are a computer program product (generally referenced 92), including a computer readable medium (e.g., a removable storage medium such as one or more DVD-ROM's, CD-ROM's, diskettes, and tapes) that provides at least a portion of the software instructions for the system. Computer program product 92 can be installed by any suitable software installation procedure, as is well known in the art. In another embodiment, at least a portion of the software instructions may also be downloaded over a cable, communication and/or wireless connection. In other embodiments, the programs are a computer program propagated signal product 75 (FIG. 4) embodied on a propagated signal on a propagation medium (e.g., a radio wave, an infrared wave, a laser wave, a sound wave, or an electrical wave propagated over a global network such as the Internet, or other network(s)). Such carrier medium or signals provide at least a portion of the software instructions for the routines/program 92.

In alternate embodiments, the propagated signal is an analog carrier wave or digital signal carried on the propagated medium. For example, the propagated signal may be a digitized signal propagated over a global network (e.g., the Internet), a telecommunications network, or other network. In one embodiment, the propagated signal is a signal that is transmitted over the propagation medium over a period of time, such as the instructions for a software application sent in packets over a network over a period of milliseconds, seconds, minutes, or longer. In another embodiment, the computer readable medium of computer program product 92 is a propagation medium that the computer system 50 may receive and read, such as by receiving the propagation medium and identifying a propagated signal embodied in the propagation medium, as described above for computer program propagated signal product. Generally speaking, the term “carrier medium” or transient carrier encompasses the foregoing transient signals, propagated signals, propagated medium, storage medium and the like. In other embodiments, the program product 92 may be implemented as a so-called Software as a Service (SaaS), or other installation or communication supporting end-users.

### REFERENCES

[1] Xuhui Ao and Naftaly H Minsky. Flexible regulation of distributed coalitions. In Computer Security—ESORICS 2003, pages 39-60. Springer, unknown, 2003.

[2] Mark Burgess. An approach to understanding policy based on autonomy and voluntary cooperation. In Ambient Networks, pages 97-108. Springer, unknown, 2005.

[3] T. Eymann, S. Konig, and R. Matros. A framework for trust and reputation in grid environments. Journal of Grid Computing, 6:225-237, 2008.

[4] Benôit Garbinato and Ian Rickebusch. Orchestrating fair exchanges between mutually distrustful web services. In Proceedings of the 3rd ACM workshop on Secure web services, pages 33-42, unknown, 2006. ACM.

[5] Tyrone Grandison and Morris Sloman. A survey of trust in interne applications. Communications Surveys & Tutorials, IEEE, 3(4):2-16, 2000.

[6] A. Jsang, J. Fabre, B. Hay, J. Dalziel, and S. Pope. Trust requirements in identity management. In Proceedings of the Australasian Information Security Workshop, Newcastle, Australia, January 2005.

[7] Arun K Kanuparthi, Mohamed Zahran, and Ramesh Karri. Feasibility study of dynamic trusted platform module. In Computer Design (ICCD), 2010 IEEE International Conference on, pages 350-355, unknown, 2010. IEEE.

[8] Angelos D Keromytis, Sotiris Ioannidis, Michael B Greenwald, and Jonathan M Smith. The strongman architecture. In DARPA Information Survivability Conference and Exposition, 2003. Proceedings, volume 1, pages 178-188, unknown, 2003. IEEE.

[9] John Lyle. Trustable remote verification of web services. In Trusted Computing, pages 153-168. Springer, unknown, 2009.

[10] Deepti Malhotra et al. A framework for trust and reputation in distributed environments. International Journal of Research & Reviews in Computer Science, 2(2):unknown, 2011.

[11] Naftaly H Minsky. Regularity-based trust in cyberspace. In Trust Management, pages 17-32. Springer, unknown, 2003.

[12] Naftaly H. Minsky. Law Governed Interaction (LGI): A Distributed Coordination and Control Mechanism (An Introduction, and a Reference Manual). Rutgers, February 2006.

[13] Naftaly H Minsky. Decentralized governance of distributed systems via interaction control. In Logic Programs, Norms and Action, pages 374-400. Springer, unknown, September 2012.

[14] Arun Muthu, Rahim Rahmani, and Dinakaran Rajaram. Emulating trust zone in android emulator with secure channeling. International Journal of Computer Science Issues (IJCSI), 10(5):70-80, 2013.

[15] Ilung Pranata, Rukshan Athauda, and Geoff Skinner. Modeling decentralized reputation-based trust for initial transactions in digital environments. ACM Transactions on Internet Technology (TOIT), 12(3):8, 2013.

[16] Hridesh Rajan and Mahantesh Hosamani. Tisa: Toward trustworthy services in a service-oriented architecture. Services Computing, IEEE Transactions on, 1(4):201-213, 2008.

[17] Jocelyn Simmonds, Yuan Gan, Marsha Chechik, Shiva Nejati, Bill O'Farrell, Elena Litani, and Julie Waterhouse. Runtime monitoring of web service conversations. Services Computing, IEEE Transactions on, 2(3):223-244, 2009.

While example embodiments have been particularly shown and described, it will be understood by those skilled in the art that various changes in form and details may be made therein without departing from the scope of the embodiments encompassed by the appended claims.

What is claimed is:

1. A system for enabling a service provider to provide to a client computing device trusted services over the internet, the system comprising:
a pledge registry accessible by the client computing device and including:
information relating to a plurality of promises, at least one promise relating to a service provided by the service provider; and
a plurality of laws corresponding to the plurality of promises, the laws used to enforce promises for client computing devices; and
a controller computing device configured to provide the service to the client computing device in accordance with the at least one promise, a law corresponding to the at least one promise implemented as a computer program running on the controller computing device.

2. A system as in claim 1 further comprising a controller provider configured to manage a plurality of controller computing devices, including the controller computing device configured to provide the service of the service provider.

3. A system as in claim 2 wherein the controller computing device is configured to authenticate itself using a certificate of authenticity signed by the controller provider.

4. A system as in claim 1 wherein the service provider is enabled to provide the controller computing device using trusted platform module technology.

5. A system as in claim 4 wherein the controller computing device is configured to authenticate itself using (i) a certificate of authenticity signed by a manufacturer of a host of the controller computing device, and (ii) a one-way hash of operating code of the controller computing device.

6. A system as in claim 1 wherein the service provider is part of a service-oriented architecture (SOA) system.

7. A system as in claim 1 wherein a controller computing device associated with providing a service according to a law is configured to enable the client computing device to identify the law associated with the controller computing device by examining a one-way hash of the law.

8. A system as in claim 7 wherein examining a one-way hash of the law includes comparing (i) the one-way hash of the law associated with the controller computing device with (ii) a one-way hash of the law received from the service provider.

9. A system as in claim 1 wherein a pledge made by a service is subordinate to another pledge, forming a conformance hierarchy of at least two pledges.

10. A system as in claim 9 wherein the controller computing device is configured to provide client computing devices with a sequence of one-way hashes of laws of the pledges in the hierarchy.

11. A method of providing a trusted service by a service provider, the method comprising:
creating a promise to offer to client computing devices of a service;
creating a law corresponding to the promise, the law used to enforce the promise for client computing devices;
integrating the law with a controller computing device as a computer program running on the controller computing device, the controller computing device used to provide the service to the client computing devices in accordance with the promise; and
providing information to the client computing devices regarding use of the controller computing device to obtain the service and regarding authentication of the controller computing device.

12. A method as in claim 11 further including:
creating a natural-language statement of the promise; and
adding to a pledge registry the natural-language statement of the promise and the law corresponding to the promise.

13. A method as in claim 11 wherein the information provided to the client computing device includes an address of the controller computing device, a public key associated with the controller computing device, and a one-way hash of the law associated with the service.

14. A method as in claim 13 wherein the controller computing device is configured to enable identification by client computing devices of the law integrated with the controller computing device based on a one-way hash of the law.

15. A method as in claim 11 wherein:
creating a promise includes accessing a pledge registry and selecting an existing promise from the pledge registry, or creating and adding a promise to the pledge registry; and
creating a law includes selecting an existing law from the pledge registry that is associated with the selected promise, or creating and adding a law to the pledge registry.

16. A method as in claim 11 wherein creating a promise includes creating a promise that is subordinate to another promise selected from the pledge registry.

17. A method of accessing a trusted service, the method comprising:
receiving from a service provider (i) a promise relating to a service and (ii) information relating to a controller computing device used to provide the service in accordance with the promise, the controller computing device including a computer program implementing a law corresponding to the promise;
accessing a pledge registry to verify information relating to the promise, including the law corresponding to the promise;
authenticating the controller computing device used to provide the service; and
interacting with the controller computing device to obtain the service in accordance with the promise.

18. A method as in claim 17 wherein the information relating to the controller computing device received from the service provider includes an address of the controller computing device, a public key associated with the controller computing device, and a one-way hash of the law associated with the service.

19. A method as in claim 17 further comprising identifying the controller computing device by examining a one-way hash of the law associated with the controller computing device.

20. A method as in claim 19 wherein examining a one-way hash of the law includes comparing (i) the one-way hash of the law associated with the controller computing device with (ii) the one-way hash of the law received from the service provider.

21. A method as in claim 17 wherein authenticating the controller computing device further includes examining a one-way hash of operating code of the controller computing device.

22. A method as in claim 17 wherein a hierarchy of pledges is associated with a service, pledges depending from a given pledge being required to be consistent with the given pledge.

23. A method as in claim 22 further comprising determining whether a law associated with a service is consistent with a corresponding pledge and a higher-level pledge from which it depends by verifying a sequence of one-way hashes corresponding to the pledge and the higher-level pledge.
